(19) United States
(12) Patent Application Publication
(10) Pub. No.: US 2003/0087455 A1
(43) Pub. Date: May 8, 2003

(54) Sample carrier system

(76) Inventors: Mitchell D. Eggers, Carlsbad, CA (US); Michael Hogan, Tucson, AZ (US)

Correspondence Address: Pillsbury Winthrop LLP, Intellectual Property Group, Suite 200, 11682 El Camino Real, San Diego, CA, 92130-2593, US

(21) Appl. No.: 10/150,771

(22) Filed: May 17, 2002

Related U.S. Application Data
(63) Continuation-in-part of application No. 10/007,355, filed on Nov. 7, 2001.

(51) Int. Cl. B01L 3/00; G01N 21/77

(52) U.S. Cl. 436/169; 435/283.1; 435/287.3; 435/287.7; 435/288.3; 435/288.4; 422/56; 422/99; 422/104; 422/102; 422/58; 422/100; 422/941; 422/942; 436/180

(57) ABSTRACT

A sample carrier generally comprises a sample node and an identifier co-located with the sample node. A sample node may be operative to carry a discrete sample, while an identifier may be operative to provide information associated with the sample carried by the sample node. Embodiments of a sample carrier may comprise a plurality of sample nodes supported in a predetermined spatial relationship relative to a respective sample container such as a respective well of a multi-well plate. A system and method of transferring specimens to a sample carrier include contacting a sample node to the specimen and encoding information associated with the specimen on the identifier. Various alternatives are disclosed wherein the specimen is solid, gaseous, and liquid in form.

The present application is a continuation-in-part of non-provisional application Ser. No. 10/007,355, filed Nov. 7, 2001, entitled “SAMPLE CARRIER.” Additionally, the present application is related to non-provisional application Ser. No. 10/005,529, filed Nov. 7, 2001, entitled “APPARATUS, SYSTEM, AND METHOD OF ARCHIVAL AND RETRIEVAL OF SAMPLES,” non-provisional application Ser. No. 10/005,415, filed Nov. 7, 2001, entitled “ARCHIVE AND ANALYSIS SYSTEM AND METHOD,” and non-provisional application Ser. No. ______, filed May 17, 2002, entitled “SAMPLE CARRIER RECEIVER.” The disclosures of all the foregoing applications are hereby incorporated by reference.

### FIELD OF THE INVENTION

Aspects of the present invention relate generally to archival of sample material, and more particularly to a system and method of storing biological or non-biological samples maintained at a sample node having a co-located sample identifier.

### DESCRIPTION OF THE RELATED ART

In many applications such as pharmaceutical and medical research, law enforcement, and military identification, for example, it is often desirable to have access to numerous biological samples. Conventional biorepositories or other sample storage facilities utilize liquid or low temperature cryogenic systems for sample storage; these liquid and cryogenic systems are expensive both to create and to maintain. Additionally, current technology generally presents system operators with complicated and labor intensive maintenance and administrative responsibilities.

Specifically, the intricacies of cryogenic systems may typically oblige technicians, researchers, and system operators to engage in coordinated labor for weeks to retrieve and to prepare thousands of deoxyribonucleic acid (DNA) samples from whole blood. Accordingly, conventional approaches for archiving DNA in liquid or cryogenic states are fundamentally inadequate to the extent that they do not accommodate high volume processing and sample throughput. Current research trends recognize benefits associated with systems and methods of archiving and retrieving biological and non-biological samples which may be capable of processing thousands of samples per day; current technology, however, is inadequate to attain throughput at this level. In fact, current systems and methods cannot attain processing throughput of one hundred or more samples per day.

Although some small volume liquid-state DNA and blood archival techniques have been useful in the past, present methodologies are not capable of supporting the increasing storage and retrieval rates required as advancing genomics technology becomes more prevalent as a research and diagnostic tool. Since the traditional cryogenic-based archival format is difficult and expensive to automate, systems based upon existing technology are generally not amenable to the high throughput demands of the market.

Recently, biological research laboratory systems have been proposed which incorporate archiving and retrieval of blood samples in dry or desiccated form. Present systems are generally based upon modifications or variations of known techniques for storing DNA or other organic samples on a suitable substrate such as filter paper; some systems require, or substantially benefit from, soaking the substrate or paper with chemical denaturants and detergents prior to use. In any event, however, existing desiccated sample archival systems are manually operated or only partially automated, and hence do not meet the high volume processing demands of the market. Additionally, traditional systems employ a mechanical punch or other tool which is operative to remove samples from substrates, typically by punching through or otherwise physically engaging the substrate material. Consequently, these tools necessarily make contact with multiple samples during ordinary use.

In that regard, those of skill in the art will appreciate that even if the current substrate-based archive systems were fully automated, significant cross contamination problems would undoubtedly remain. During the sample removal punching process, extraneous fibers adhere to the punching tool or are otherwise released from the substrate, contaminating subsequent samples handled by the tool. These contamination problems limit both the utility and the practicality of traditional technologies. Moreover, the density of the storage facility is ultimately limited by the inherent saturation limit of the substrate, as well as by the precision of mechanical and robotic components of the system.

Further, current systems employing desiccated sample storage technology do not incorporate adequate sample identifiers or techniques; this lack of integrated, attached, or “co-located” identification for each discrete sample represents an additional shortcoming of conventional filter paper based sample archiving methodologies. In the above-described punch process, for example, an individual sample is not directly labeled or otherwise identified following removal from the filter paper. Accordingly, one particular desiccated sample or specimen may not be distinguishable from any other sample, either visually or otherwise. In particular, the potential for sample handling errors significantly increases, since each discrete sample is not provided with an associated identification.

### SUMMARY

Embodiments of the present invention overcome the foregoing and various other shortcomings of conventional technology, providing an associated individual identifier co-located with each discrete sample.

As set forth in detail below, a sample carrier may generally comprise a sample node operative to carry a discrete sample and an identifier, co-located with the sample node, operative to provide information associated with the sample carried by the sample node. Embodiments of a sample carrier may comprise a plurality of sample nodes supported in a predetermined spatial relationship relative to a respective sample container such as a respective well of a multi-well plate. A system and method of transferring specimens to a sample carrier include contacting a sample node to the specimen and encoding information associated with the specimen on the identifier. Various alternatives are disclosed wherein the specimen is solid, gaseous, and liquid in form.

In accordance with some embodiments, for example, a sample node is operative to carry a biological or a non-biological sample. Biological samples may comprise biopolymers, proteins, polynucleotides such as RNA or DNA, enzymes, and the like.

In some embodiments, the identifier may comprise identifying indicia, for example, which may be decipherable by an optical sensor; such indicia may include a one- or two-dimensional bar code. Additionally or alternatively, the identifier may comprise a transceiver operative to transmit a signal identifying the discrete sample supported at the sample node. The transceiver may further be operative to receive a signal from a remote device; in some implementations, the transceiver receives operational power from energy in the signal, which may comprise light (such as fluorescent or coherent light) or other electromagnetic energy (such as radio frequency or microwave energy, for example).

In some embodiments of a sample carrier, the transceiver is internal to the sample node, which may be solid or porous, and generally comprises a sample support medium operative to support the biological or non-biological sample. In accordance with some embodiments, a sample support medium comprises cellulose (such as filter paper, for example) or a polymer (such as polystyrene or chitosan). The sample support medium may be derivatized, positively charged or negatively charged, for example.

The sample carrier may include an identifier (such as the transceiver noted above) which is internal to the sample node. In accordance with some embodiments, an identifier may be permanently co-located with the sample node; further, a sample carrier may comprise magnetic material, wherein the sample carrier may be selectively oriented responsive to an applied magnetic field.

As noted generally above, a sample carrier constructed and operative in accordance with the present disclosure may comprise: a plurality of sample nodes supported in a predetermined spatial relationship, each of which may be operative to carry a discrete sample; and a plurality of identifiers, each of which may be co-located with a respective one of the plurality of sample nodes and operative to provide information associated with the discrete sample.

Each of the plurality of sample nodes may be supported in a predetermined spatial relationship relative to a respective specimen container such as a respective well of a multi-well plate.

In accordance with another aspect of the present invention, a method of transferring a specimen to a sample carrier comprises: providing a sample carrier comprising a sample node operative to carry a discrete sample and an identifier co-located with the sample node and operative to provide information associated with the discrete sample; and contacting the sample node and the specimen. As described herein, the specimen may be solid, gaseous, or liquid.

In conjunction with the foregoing method, the sample node may comprise a preservative and may be subject to washing or allowed to desiccate subsequent to the contacting.

As noted above, an identifier operative in accordance with such a method may comprise a bar code or other indicia identifying the specimen; an identifier may comprise a transceiver operative to transmit a signal identifying the specimen. Further, the identifier may be permanently co-located with the sample node.

In some embodiments, a method of transferring a specimen to a sample carrier may additionally comprise combining a magnetic material with the specimen prior to the contacting; accordingly, a sample carrier loaded with specimen may be oriented or manipulated responsive to an applied magnetic field.

Some methods of transferring specimens to a sample carrier comprise: providing a sample carrier comprising a plurality of sample nodes supported in a predetermined spatial relationship relative to a respective specimen container and a plurality of identifiers, each respective one of the plurality of identifiers co-located with a respective one of the plurality of sample nodes and operative to provide information associated with the discrete sample; and contacting selected ones of the plurality of sample nodes and a respective specimen.

In general, contacting selected ones of the plurality of sample nodes and a respective specimen comprises bringing the plurality of sample nodes into contact with a specimen in the respective specimen container.

In accordance with another aspect of the disclosed system and method, a sample carrier may generally comprise: a sample node; an identifier co-located with the sample node; and a specimen carried by the sample node; wherein the identifier is operative to provide information associated with the specimen. The sample node may be treated with a chemical compound.

In some embodiments, it may be desirable that the identifier is permanently co-located with the sample node, such as by permanent attachment or by incorporation of the identifier within the sample node itself. Further, a sample carrier may additionally comprise magnetic material such that the sample carrier may be oriented responsive to an applied magnetic field.

The foregoing and other aspects of various embodiments of the present invention will be apparent through examination of the following detailed description thereof in conjunction with the accompanying drawings.

### BRIEF DESCRIPTION OF THE DRAWINGS

FIG. 1A is a simplified diagram illustrating one embodiment of a sample carrier.

FIG. 1B is a simplified diagram illustrating one embodiment of a sample carrier receiver.

FIG. 2A is a simplified diagram illustrating another embodiment of a sample carrier.

FIG. 2B is a simplified diagram illustrating an embodiment of a sample carrier receiver including a conduit system.

FIG. 2C is a simplified diagram illustrating a cross sectional plan view of one embodiment of a sample carrier receiver including a conduit system in cross section.

FIG. 2D is a simplified diagram illustrating a cross sectional plan view of another embodiment of a sample carrier receiver including a conduit system in cross section.

FIG. 2E is a simplified diagram illustrating a partially exploded, transverse cross sectional view of one embodiment of a sample carrier receiver including a conduit system.

FIG. 2F is a simplified diagram illustrating a partially exploded, transverse cross sectional view of another embodiment of a sample carrier receiver including a conduit system.

FIG. 3 is a simplified partial cross-sectional diagram of one embodiment of a sample carrier receiver.

FIG. 4 is a simplified partial cross-sectional diagram of another embodiment of a sample carrier receiver.

FIG. 5 is a simplified partial cross-sectional diagram of another embodiment of a sample carrier receiver.

FIG. 6 is a simplified diagram illustrating another embodiment of a sample carrier.

FIG. 7 is a simplified diagram illustrating one embodiment of a sample identifier configured for use with the sample carrier embodiment of FIG. 6.

FIG. 8 is a simplified diagram illustrating another embodiment of a sample carrier.

FIG. 9 is a simplified diagram illustrating another embodiment of a sample identifier.

FIG. 10 is a simplified diagram illustrating another embodiment of a sample carrier.

FIG. 11 is a simplified diagram illustrating another embodiment of a sample carrier.

FIG. 12 is a simplified diagram illustrating another embodiment of a sample carrier.

FIG. 13 is a simplified diagram illustrating one embodiment of a sample carrier receiver configured for use with the sample carrier embodiment of FIG. 12.

FIG. 14 is a simplified flow diagram illustrating one embodiment of a sample archival method.

### DETAILED DESCRIPTION

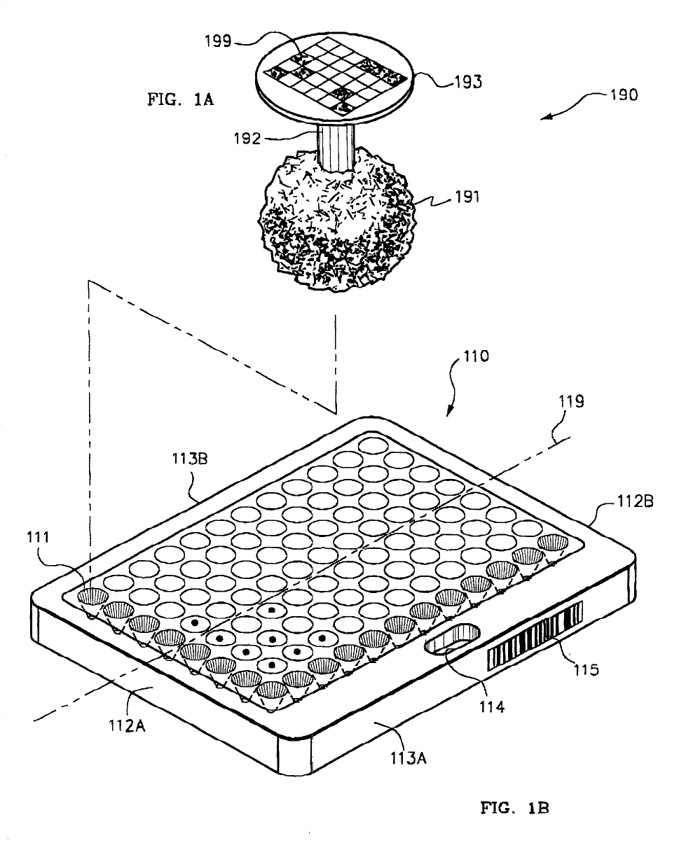

Turning now to the drawings, FIG. 1A is a simplified diagram illustrating one embodiment of a sample carrier. As illustrated in FIG. 1A, a sample carrier 190 may generally comprise a sample node 191 operative to carry a discrete sample and a sample identifier 199 operative to provide information associated with the discrete sample carried at node 191.

As indicated in FIG. 1A, carrier 190 may include one or more physical structures, such as stem 192, configured and operative to support an identification and handling structure 193 to which identifier 199 may be attached. It is noted that the depiction of carrier 190 is representative only, and that, in particular, the characterization of stem 192 and identification structure 193 is not intended to be interpreted in any limiting sense. Specifically, the structural arrangement of the components of sample carrier 190 is susceptible of various modifications and alterations depending upon, among other things, the material from which the components are fabricated, the functionality of any automated handling mechanisms with which carrier 190 is intended to be used, and the structural characteristics of a sample carrier receiver with which carrier 190 is intended to be engaged as set forth in more detail below.

In that regard, the relative proportions, size, length, diameter, and other physical characteristics of stem 192 and identification structure 193 may be selected in accordance with the intended use of carrier 190. In some embodiments, for example, carrier 190 may be grasped and transported or otherwise manipulated by robotic gripping mechanisms, vacuum or magnetic chucks, or other automatic apparatus; accordingly, identification structure 193 and stem 192 may constructed of suitable material and be so dimensioned as to provide sufficient rigidity and structural integrity to withstand any external forces exerted by automatic handling or gripping devices on identification structure 193. Similarly, as set forth herein, carrier 190 may be configured and operative to engage a sample carrier receiver (such as represented by reference numeral 110 in FIG. 1B, for example) during use; accordingly, the length of stem 192 and the diameter and thickness of identification structure 193 may be suitably dimensioned to facilitate interoperation of carrier 190 with such a receiver.

Structural elements of carrier 190 may be constructed of any material with sufficient rigidity to enable the manipulation and transport of carrier 190 by robotics or other automated mechanisms as described above. It will be appreciated that the structural elements of carrier 190, including sample node 191, may be formed or molded as an integrated unit, for example; in some embodiments, carrier 190 may be fabricated using injection molding techniques generally known in the art, for instance. Alternatively, some or all of the components may be fabricated individually and subsequently attached, adhered, fused, joined, or otherwise integrated to form a unified structure for carrier 190. Sample node 191, stem 192, and identification structure 193 may be fabricated of polystyrene or various plastics, for example, such that the overall structure of carrier 190 is afforded suitable stiffness without rendering carrier 190 unnecessarily heavy or cumbersome. It will be appreciated that various fabrication techniques generally known in the art may be used to construct carrier 190 and the various components illustrated in FIG. 1A. The present disclosure is not intended to be limited to any particular materials or construction methods employed with respect to fabrication of carrier 190.

As noted generally above, the exemplary embodiment of carrier 190 generally comprises sample node 191 operative to carry a discrete sample and identifier 199 operative to provide information associated with the discrete sample carried at node 191. In the illustrated arrangement, identifier 199 is co-located with the sample it identifies.

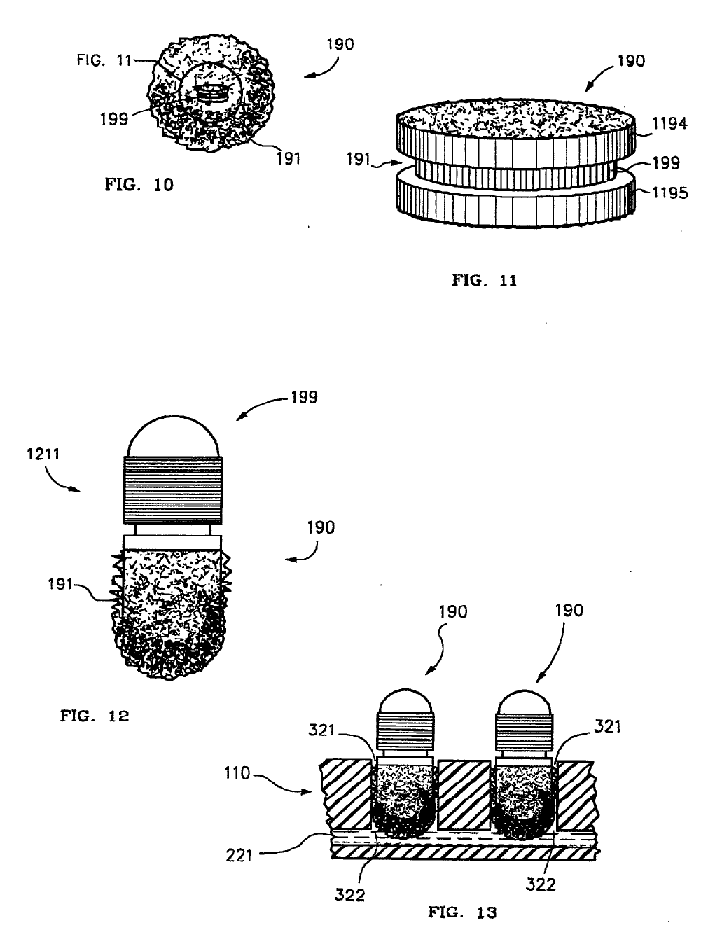

The term “co-located” in this context generally refers to the location of both the sample and identification or other information associated with the sample. For instance, identifier 199 may be attached, adhered, fused, coupled, or otherwise connected to node 191 as described above, for example, via suitable components such as stem 192 and identification structure 193; alternatively, as described in detail below with reference to FIGS. 10 and 11, identifier 199 may be integral with or incorporated into the structure of node 191 itself such that supporting or attaching structures may be omitted.

In that regard, identifier 199 and node 191 may be “permanently” co-located such as through physical attachment (e.g. FIG. 1A) or through integration of identifier 199 with node 191 (see, e.g. FIGS. 10 and 11). Accordingly, unique identification information and other data may be co-located with the sample carried at node 191 throughout the useful life of sample carrier 190 (i.e. until sample material is removed or extracted from node 191 for experimentation or other use).

Permanently co-locating node 191 and identifier 199 substantially as set forth herein may ensure that information associated with a particular discrete sample is always available at the location of that sample. Accordingly, handling errors (arising for example, due to misplacement of node 191) may be minimized or eliminated, since the sample at node 191 may be identified by reference to identifier 199, and since identifier 199 is integrated with or connected to node 191.

It will be appreciated that sample node 191 may be substantially spherical as represented in FIG. 1A; alternatively, node 191 may be formed in any of numerous shapes and sizes; by way of example, two possibilities are illustrated in FIGS. 11 and 12. Those of skill in the art will appreciate that several polygons, polyhedrons, pyramidal or triangular shapes, disks (FIG. 11), or oblong (FIG. 12) embodiments are contemplated and may be selected based upon various factors such as the desired node size and density, the saturation limit of the material used for sample node 191, the accuracy and precision of the device used to manipulate sample carrier 190, and the like. The present disclosure is not intended to be limited by the shape, size, or dimensional characteristics of sample node 191.

Sample node 191 may bind sample material directly or indirectly. In that regard, an exemplary node 191 may generally comprise, or be constructed entirely of, a sample support medium. In some embodiments, for example, node 191 may simply be coated with a selected sample support medium such that node 191 binds a sample indirectly; alternatively, the entire structure of node 191 may be fabricated of a sample support medium (i.e. sample support medium may constitute the structure of node 191) to bind the sample directly. In accordance with one aspect of the present invention, sample support media for use at sample node 191 may be embodied in paper or cellulose, polymers such as polystyrene or chitosan, plastic, ceramic, or other suitable support material constructed and operative to serve as a long-term storage mechanism for biological or other sample material. Specimen material in solid, liquid, or gaseous form may be brought into contact with the sample support medium and stored as a sample at discrete sample node 191.

In some embodiments, for example, such a sample support medium may maintain samples of biopolymers, including polynucleotides such as ribonucleic acid (RNA) and deoxyribonucleic acid (DNA) as well as proteins, or non-biological samples, including fluorocarbons or chlorofluorocarbons (CFCs), environmental pollutants, and synthetic chemical compounds. As noted above, filter paper substrate embodiments are currently known in the art; for example, U.S. Pat. No. 6,294,203 discloses a dry solid medium for storage of sample material which may be suitable for incorporation into sample carrier 190. The disclosure of this United States Patent is hereby incorporated by reference in its entirety.

The present disclosure is not intended to be limited with respect to specific sample support media employed at node 191. Accordingly, a support medium suitable for implementation at sample node 191 may generally comprise any appropriate material known in the art or developed and operative in accordance with known principles, and may be selected in accordance with binding properties as a function of the type of sample to be carried and maintained.

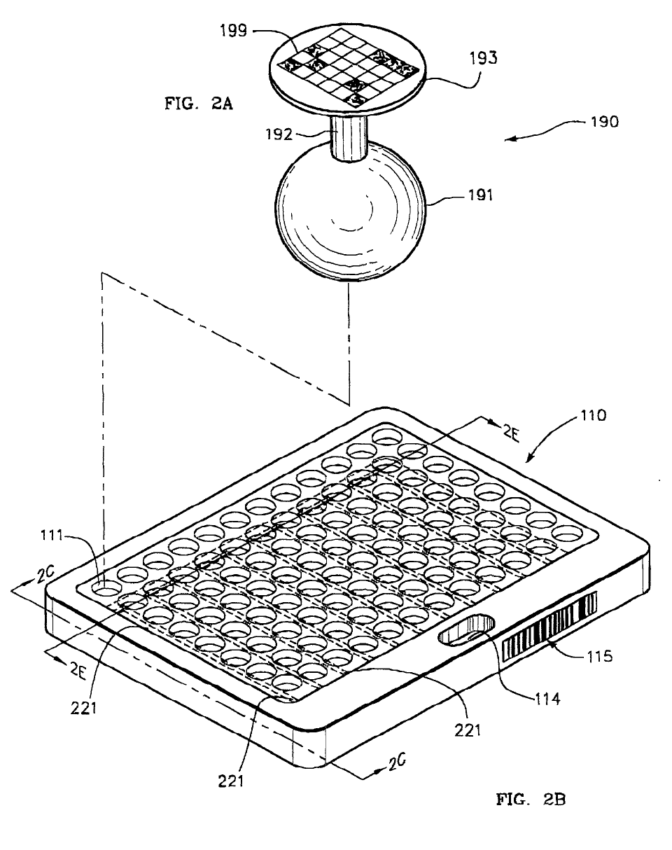

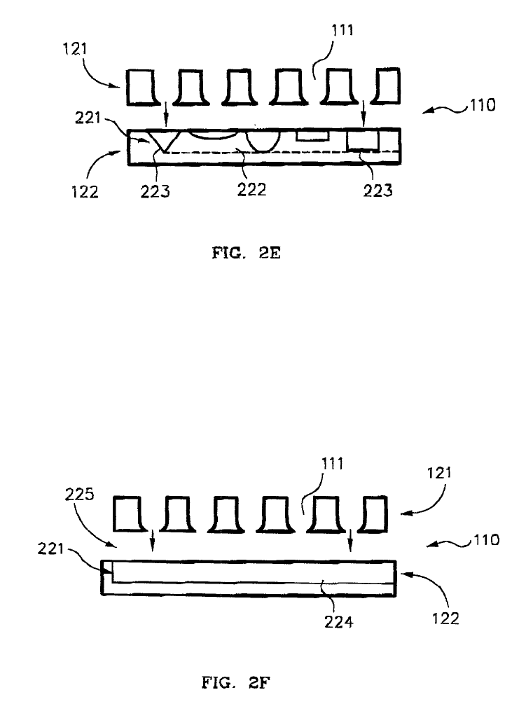

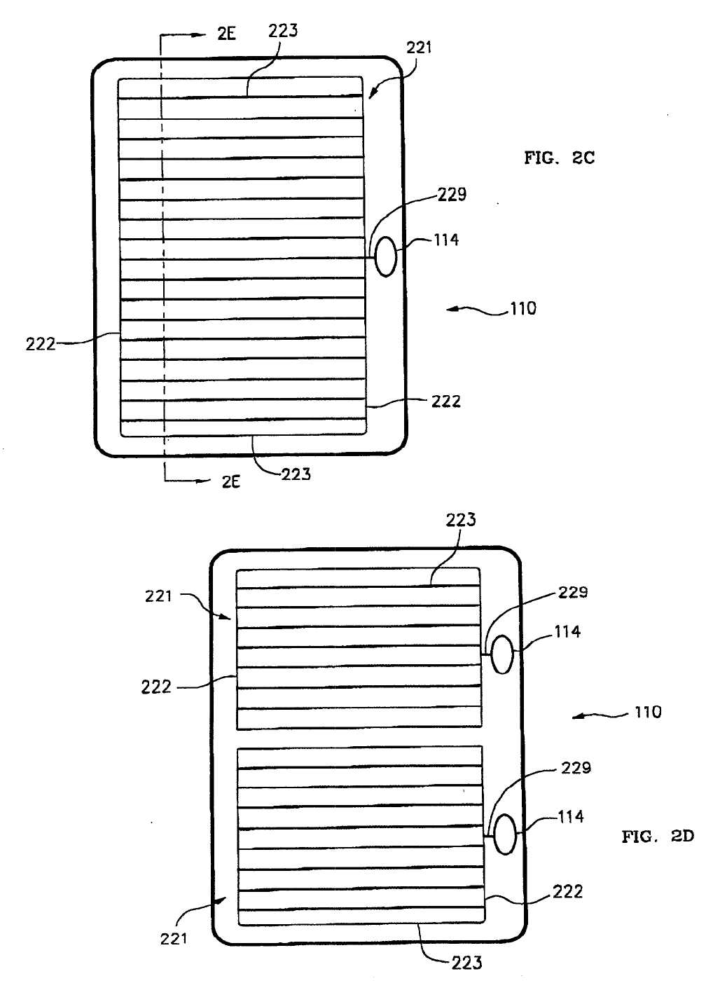

In that regard, an appropriate sample support medium may be solid (see, e.g. FIG. 2A) or porous (such as represented by node 191 in FIG. 1A), for example, depending, in part, upon the type of specimen to be stored as a sample at node 191. Additionally or alternatively, sample support medium may be treated with one or more chemical compounds or derivatized, for instance, to manipulate various binding properties prior to contact with a specimen. Positive or negative electrical charges, chemical compositions, binding characteristics, antibodies, lectins, porosity, and other operational factors for sample node 191 may be selected in accordance with the type of sample support medium implemented and the type or nature of any processes performed thereon.

Biological and non-biological samples may be stored in a controlled environment. In that regard, humidity, temperature, and other environmental factors may be controlled in a fireproof vault or other structure employed as an archive. In some embodiments, environmental conditions may be selectively altered depending, for instance, upon the nature of the samples, the composition of the sample support medium employed at sample node 191, or both, to preserve longevity of the samples for decades. In a biopolymer (such as a polynucleotide) archival embodiment, for example, the sample support medium may include a chemically treated surface or structure, serving to lyse particular specimen cells and to immobilize the polynucleotide structure to the sample support medium or substrate at discrete sample node 191. Additionally or alternatively, preservatives may be applied, embedded, impregnated, or otherwise incorporated onto or into the sample support medium; such preservatives may ensure the stability and fidelity of the polynucleotide structure for tens of years. Sample node 191, which may be characterized by a discrete pellet or sphere as represented in FIG. 1A, may be selectively deposited in a particular well disposed in a multi-well plate as represented in FIG. 1B; samples deposited in particular wells may, in turn, be selected for subsequent processing (e.g. such as with polymerase chain reaction (PCR) assays, and the like).

Cross contamination may be virtually eliminated by storing a sample on node 191. In some instances, mechanical contact involving a mechanical sample removal device may be entirely eliminated during retrieval, extraction, purification, packaging, and shipping. Moreover, since carrier 190 or handling and identification structure 193 may be amenable to manipulation by standard robotics, an entire archive facility may be easily automated to achieve high throughput rates (for example, greater than one hundred samples per day).

Polynucleotides such as DNA or RNA archived and retrieved using sample carrier 190 as set forth above may be well suited for large-scale genetic analysis, and may yield samples which are superior (relative to conventional liquid phase or cryogenic technologies) for pharmacogenetics or other types of genetic discovery analyses. Specifically, implementation of sample node 191 may automatically standardize the quantity and quality of polynucleotide storage due to the inherent loading properties of the sample support medium and any embedded chemicals serving to diminish PCR inhibitors; accordingly, the requirements and complexities of quantification procedures following purification in conventional polynucleotide extraction may be simplified, reduced, or eliminated entirely. Additionally, desiccated archive samples are not continuously degraded during repeated freezing and thawing cycles as is common in cryogenic systems.

In operation, identifier 199 may generally maintain or provide information associated with the discrete sample carried at node 191. In some embodiments, identifier 199 may enable access to such information, maintaining or providing a unique code, serial number, or other identifying indicia associated with the sample; in such embodiments, a database or other record store may be interrogated or queried for information associated with the sample using the code or signal displayed or provided by identifier 199.

In this context, therefore, and to simplify further discussion, it will be appreciated that the functionality of identifier 199 referred to as “providing” information associated with a sample generally encompasses, without limitation: maintaining or storing such information, in whole or in part, at identifier 199; communicating, transmitting, or otherwise conveying such information, in whole or in part, from identifier 199; and reflecting, signaling, transmitting, or otherwise communicating a unique code, signal, data stream, or other indicator operative to identify the sample and to enable access to such information.

In the FIG. 1A embodiment, for instance, identifier 199 generally comprises identifying indicia by which a sample carried at node 191 may be uniquely identified. In that regard, identifier 199 may comprise a two-dimensional bar code having light and dark areas such as indicated in FIG. 1A; similarly, identifier 199 may include a one-dimensional bar code having parallel lines of varying width and separation. Additionally or alternatively, identifier 199 may comprise a serial number, lot number, alpha-numeric code, or other symbolic representation suitable to identify or to distinguish sample material carried at node 191. Such bar codes or other identifying indicia may be scanned by any of various machine vision or other optical sensors or reading devices generally known in the art. In these embodiments, identifier 199 may maintain or provide a unique sample identification encoded in the bar code or identifying indicia; accordingly, information associated with the sample at node 191 may be obtained or accessed using the unique identifying encoded in the indicia.

In some embodiments, for example, optical reading equipment may generally comprise machine vision technology, video cameras, or other optical sensors which are capable of identifying or locating the elements represented in the bar code or other indicia of identifier 199 using instruments or receptors which are sensitive to various portions of the electromagnetic spectrum. In this embodiment, optical information (from the visible portion of the spectrum) or other electromagnetic information (such as microwave or infrared frequencies, for example) may be used to ascertain the identity, nature, and general constitution of the co-located sample carried at node 191.

Sample identification and other information maintained and provided by identifier 199 may generally include, but is not limited to: a distinct identifier code or other indicia enabling accurate identification and tracking of the sample; the nature or type of sample (e.g. blood, DNA, RNA, protein, environmental particles, or pollutants); the source or origin of the sample (e.g. age, gender, and medical history of a person, or the location and circumstances under which an environmental sample was collected); the time and date the sample was collected or archived; and the like. Data records or other structures representative of this information may be encoded in identifier 199 itself, for example, or may be maintained in a database or other data storage structure or facility.

In some implementations, sample carrier 190 may be designed or configured to engage a sample container such as a well in a standard or modified multi-well plate. When carrier 190 is engaged with such a container or sample carrier receiver, node 191 may be brought into contact with specimen material in the well; alternatively, carrier 190 may engage a clean or unused well (i.e. one containing no specimen material or traces of contaminants) such that the sample material at node 191 may be stored and cross-contamination between samples carried at individual sample nodes may be prevented.

FIG. 1B is a simplified diagram illustrating one embodiment of a sample carrier receiver. In the illustrated embodiment, sample carrier receiver 110 generally comprises a plurality of sample containers or wells 111 arranged in a predetermined orientation relative to a longitudinal axis 119. Each well 111 may be configured and operative to receive a sample carrier 190, and more particularly, a sample node 191 substantially as described above and set forth in more detail below.

It will be appreciated by those of skill in the art that the FIG. 1B embodiment of receiver 110 is illustrated by way of example only, and not by way of limitation. Various shapes of receiver 110 and configurations of wells 111 are within the scope and contemplation of the present disclosure. While a rectangular configuration is illustrated and described herein, for example, receiver 110 may alternatively be generally circular or generally square in plan, depending for example, upon the requirements or configuration of the laboratory or archive facility in which receiver 110 is utilized.

In an exemplary rectangular embodiment, receiver 110 generally comprises longitudinal sides 113A, 113B and transverse sides 112A, 112B. Those of skill in the art will appreciate that scientific sample storage and experimentation systems may employ robotic mechanisms for grasping, translating, or otherwise manipulating multi-well plates in a laboratory or sample archive facility. Accordingly, sides 112A-B, 113A-B may be shaped and dimensioned such that suitable gripping or sample handling mechanisms may engage receiver 110 for appropriate or desired manipulation.

In that regard, receiver 110 may generally be fabricated of any suitable material providing sufficient rigidity and strength to withstand forces exerted by such automated or robotic systems. It may also be desirable to construct receiver 110 of material which will not contaminate any sample or specimen material contained in wells 111. Various plastics, ceramics, polystyrenes, polymeric and other materials generally known in the art for constructing multi-well plates may be suitable for receiver 110, wells 111, and other components of receiver 110 described below.

Receiver 110 may be fabricated as a single unit, for example, or may generally comprise two or more pieces fabricated individually and subsequently joined, adhered, or otherwise connected.

Additionally, receiver 110 may be constructed and operative to support a label, tag, decal, or other identifying indicia 115 which may be unique to receiver 110. As is generally known in the art, identifying indicia 115 may incorporate a bar code (e.g. either one-dimensional as illustrated in FIG. 1B, or two-dimensional as illustrated in FIG. 1A), a serial number, or other alpha-numeric or symbolic representation, for example, and may distinguish receiver 110 from other sample carrier receivers maintained in an archive or laboratory facility. In such an embodiment, indicia 115 may be placed or oriented on a selected side 112A-B, 113A-B such that indicia 115 are not obscured or marred by robotics or other mechanisms designed to handle receiver 110.

With reference now to both FIGS. 1A and 1B, it will be readily apparent that carrier 190 and receiver 110 may be constructed and dimensioned such that sample node 191 is supported in a predetermined spatial relationship relative to specimen material contained in a respective container such as well 111. By way of example, sample node 191 may be placed in a position to contact specimen material in well 111. In accordance with conventional multi-well plate implementations, it is necessary to insert or to deposit specimen material into well 111 through the opening which defines the sample container (i.e. well 111) itself. In other words, it is not possible to introduce specimen material into well 111 (i.e. “load” well 111 with specimen) from the bottom or lower extremity of well 111.

As set forth in more detail below, receiver 110 may additionally comprise a duct or manifold 114 configured and operative to receive specimen material; in accordance with some embodiments, specimen material may be distributed from manifold 114 to every well 111 (or to a selected plurality of wells) in receiver 110 through one or more conduits (not shown in FIG. 1B).

Accordingly, each well 111 or specimen container in receiver 110 may generally comprise a first opening configured and operative to receive a sample node (such as node 191 in FIG. 1A) and a second opening, in communication with a conduit, for example, configured and operative to receive specimen material introduced at and distributed by manifold 114. In such an arrangement, sophisticated robotics and alignment mechanisms may be omitted from the well loading process, since a single source of specimen material injected or otherwise introduced at manifold 114 may provide sufficient material to load each well 111 in receiver 110 through a respective second opening in communication with manifold 114.

Those of skill in the art will appreciate that receiver 110 may include or be configured to accommodate a lid or cover (not shown) such as generally used in conjunction with multi-well plates. In some embodiments, indicia 115 may be placed or oriented such that a cover, when operatively engaged with receiver 110, does not obscure indicia 115; alternatively, a cover for use with receiver 110 may be modified or specifically constructed so as not to obscure indicia 115.

FIG. 2A is a simplified diagram illustrating another embodiment of a sample carrier. Carrier 190 generally corresponds to that described in detail above with reference to FIG. 1A, and may include all of the structural elements and functional characteristics set forth above. Whereas node 191 described above is illustrated as porous (represented by the rough textured appearance) in FIG. 1A, the embodiment of node 191 indicated in FIG. 2A may be solid or non-porous (represented by the generally smooth textured appearance). As set forth above, the FIG. 2A embodiment of node 191 may be constructed entirely of a non-porous sample support medium; alternatively, node 191 may comprise a coating of non-porous or solid sample support medium.

FIG. 2B is a simplified diagram illustrating an embodiment of a sample carrier receiver including a conduit system. Receiver 110 generally corresponds to that described in detail above with reference to FIG. 1B, and may include all of the structural elements and functional characteristics set forth above. The FIG. 2B illustration additionally depicts a conduit system 221 represented by the dashed lines. Conduit system 221 may generally be in fluid communication with manifold 114 and may be operative to distribute liquid sample material from manifold 114 to a second opening in each well 111 in receiver.

The terms “conduit” and “conduit system” in this context generally refer to any structure or mechanism capable of communicating specimen material, such as a liquid specimen, for instance, from manifold 114 to respective second openings in wells 111 as set forth in more detail below. For example, conduit system 221 may generally comprise tubes, ducts, or bores, of any cross-sectional shape and desired cross-sectional area, in fluid communication with manifold 114 and operative to channel, direct, or otherwise distribute specimen material to all, or to only a selected number, of wells 111. Additionally, conduit system 221 may be embodied as a simple tray, pool, cistern, trough, pan, reservoir, or other structure in fluid communication with both manifold 114 and wells 111.

It will be appreciated that each well 111 coupled to manifold 114 by conduit system 221 may be provided with a portion of the same sample or specimen material. Alternatively, receiver 110 may be implemented with one or more additional manifolds (not shown) coupled to conduit system 221, for example, or to one or more additional conduit systems (not shown). Accordingly, one or more different specimen materials may be selectively distributed to various wells 111 in receiver 1110 depending upon the number and intricacy of the manifolds and conduit systems employed in receiver 110 as illustrated, for example, in FIG. 2D.

FIGS. 2C and 2D are simplified diagrams illustrating cross-sectional plan views (taken on the line 2C in FIG. 2B) of embodiments of a sample carrier receiver including a conduit system. In the FIG. 2C embodiment, conduit system 221 may distribute liquid specimen material from manifold 114 to longitudinal conduits 222 and to transverse conduits 223 via port 229. While the FIG. 2C conduit system 221 may provide specimen material to every well in receiver 110, the FIG. 2D receiver 110 generally comprises two conduit systems 221, each of which may be coupled to a respective manifold 114 having a port 229 configured and operative to feed liquid specimen material to a respective array of longitudinal conduits 222 and transverse conduits 223 substantially as described above. Accordingly, each conduit system 221 in FIG. 2D may be operative to distribute specimen material to selected wells in receiver 110. Additional conduit systems or manifolds may be added as desired.

It is noted that specimen or sample containers such (as wells 111 illustrated in FIGS. 1B and 2B) may be arranged or oriented along longitudinal (222) or transverse (223) conduits, or at the intersections thereof, such that each container's respective second opening is in fluid communication with conduit system 221; in that regard, one or more additional conduits may be provided, or one or more illustrated conduits may be omitted, in either embodiment depicted in FIGS. 2C and 2D. The present disclosure is not intended to be limited by the specific number, orientation or directionality, or interrelation of the conduits 222, 223 implemented in conduit system 221.

FIGS. 2E and 2F are simplified diagrams illustrating partially exploded, transverse cross sectional views (taken on the line 2E in FIGS. 2B and 2C) of embodiments of a sample carrier receiver including a conduit system. As indicated in FIG. 2E, a conduit system 221 for receiver 110 may generally comprise one or more longitudinal conduits 222 and one or more transverse conduits 223. In the exemplary embodiment, conduits 222, 223 may be fabricated as channels or troughs, for example, and may communicate fluid to respective second openings of wells 111 as set forth in more detail below.

Conduits 222, 223 may generally be embodied in various cross sectional shapes and sizes as indicated in FIG. 2E depending, for example, upon the amount of liquid specimen material used in conjunction with receiver 110 and the pressure with which that specimen material is delivered to manifold 114. Those of skill in the art will appreciate that viscosity, surface tension, and various other fluid properties of the specimen material may also influence the cross sectional shape and area of conduits 222, 223.

As illustrated in FIG. 2F, for example, conduit system 221 may be embodied in a simple reservoir, pan, or tray 224 operative to receive liquid specimen material from manifold 114 or otherwise, such as through opening 225, if provided. In that regard, it is noted that a receiver 110 as depicted in FIGS. 2E and 2F may generally comprise or be fabricated of two distinct portions or sections: a first section 121 accommodating wells 111; and a second section 122 accommodating conduit system 221. In accordance with some manufacturing techniques, for example, fabrication of receiver 110 may be simplified significantly if boring, drilling, or otherwise creating conduit system 221 in general, and conduits 222, 223 in particular, in a one-piece receiver 110 is not required.

First and second sections 121, 122 may be joined or connected after fabrication, as represented by the downward arrows in FIGS. 2E and 2F. Alternatively, these components may be used independently, such that sections 121, 122 are only engaged during use, i.e. when specimen material is loaded onto sample carriers as set forth in more detail below. In embodiments integrating sections 121 and 122 into a single, one-piece receiver 110, one or more manifolds 114 may be implemented to provide liquid specimen to conduit system 221 as set forth above; where sections 121 and 122 are employed independently, however, a manifold and port for supplying conduit system 221 with specimen may not be required.

FIG. 3 is a simplified partial cross-sectional diagram of one embodiment of a sample carrier receiver. In the exemplary FIG. 3 embodiment, receiver 110 generally comprises a plurality of sample containers or wells 111 and at least one conduit system 221 substantially as set forth in detail above. As described in general above, each respective well 111 comprises a first opening 321 configured to receive a node 191 of a sample carrier 190 and a second opening 322 configured and operative to receive a specimen.

In that regard, each respective second opening 322 may be coupled to conduit system 221 to facilitate communication of liquid specimen material through second opening 322 and into well 111; as noted above, such specimen material may be introduced to conduit system 221 through one or more manifolds such as illustrated in FIGS. 1B and 2B.

Liquid specimen material may occupy or fill well 111 to a level which allows the liquid specimen to contact node 191. In some embodiments, for example, it may be sufficient that liquid sample material rises in well 111 to the level indicated by reference numeral 398; this arrangement may be suitable in situations where node 191 or the sample support medium implemented at node 191 is adapted to absorb (or “wick”) liquid specimen material readily. Alternatively, specimen material may be allowed to communicate through second opening 322 until more of node 191 is in contact with the specimen material, e.g. until the level indicated by reference numeral 399 is reached.

The shape and dimensional characteristics of each respective well 111 may be influenced by the design of sample carrier 190 with which receiver 110 is intended to be used. In particular, the shape and dimensions of well 111 may be selected in accordance with the relative sizes and shapes of node 191, stem 192, and identification and handling structure 193. As indicated in FIG. 3, for example, well 111 may generally be tapered, cupped, or otherwise configured to be narrower at the end proximal second opening 322 than at the end proximal first opening 321. In accordance with the FIG. 3 embodiment, node 191 may be supported by at least a portion of the sides or walls of well 111 such that identification structure 193 is maintained at or above the level of a surface 117 of receiver 110; stem 192 may be sized and well 111 may be designed appropriately to provide adequate clearance as desired.

It will be appreciated that the foregoing embodiment may facilitate manual or automatic placement and removal of carrier 190 with respect to well 111. For example, manual or robotic gripping mechanisms may readily grasp identification structure 193 even when carrier 190 is engaged with well 111 of receiver 110. The relative sizes of well 111 and carrier 190 depicted in FIG. 3 may, however, be susceptible of particulate matter or other contaminants being introduced into well 111 through first opening 321; additionally or alternatively, the FIG. 3 arrangement may require that a cover or lid be customized or modified for use with receiver 110.

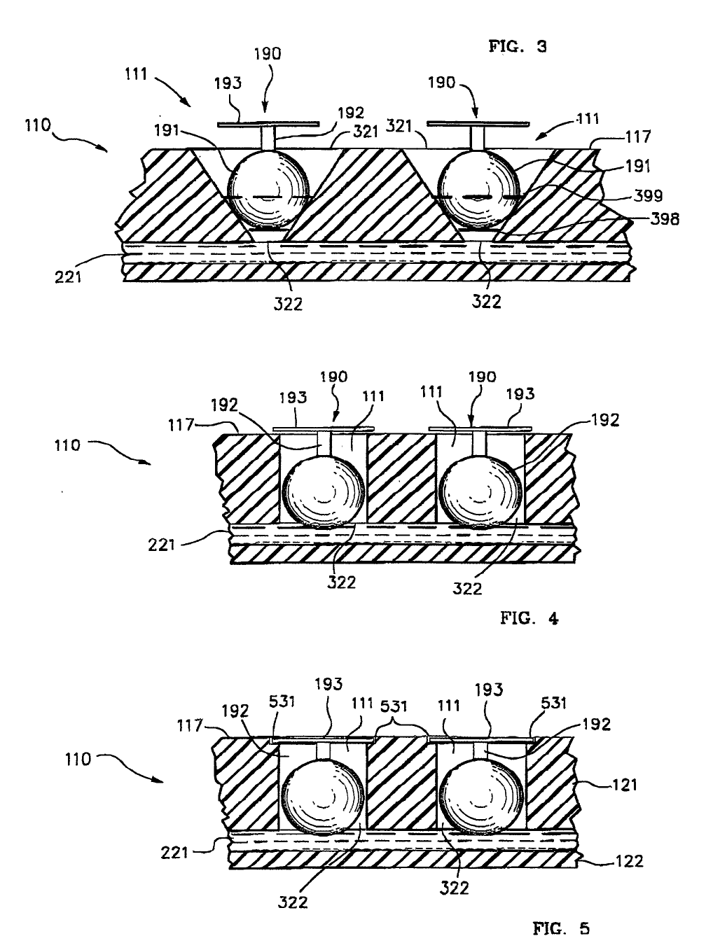

FIGS. 4 and 5 are simplified partial cross-sectional diagrams of additional embodiments of a sample carrier receiver. In these exemplary embodiments, well 111 may be provided with substantially vertical walls (i.e. without taper or narrowing toward second opening 322). As illustrated in FIG. 4, well 111 and identification structure 193 may be so dimensioned as to allow identification structure 193 to rest on, or to be supported by, surface 117 of receiver 110. In the alternative illustrated in FIG. 5, surface 117 of receiver 110 may be counter-sunk in an area proximal each respective first opening 321 as represented by reference numeral 531; additionally, identification structure 193 may be so dimensioned as to engage counter-sunk area 531 such that a surface of identification structure 193 is substantially flush or co-planar with surface 117.

The foregoing embodiments may substantially reduce the risk of contamination entering well 111 through first opening 321 when carrier 190 is operatively engaged with receiver 110; further, the arrangements of FIGS. 4 and 5 may accommodate a standard lid or cover for receiver 110 with little or no modification. Retrieval of carrier 190 from well 111 may be facilitated by automatic or robotic equipment, for example, operative to engage identification structure 193 such as with vacuum or magnetic chucks.

As noted above, the length of stem 192 may be selected in accordance with the dimensions of well 111, the size and shape of node 191, or a combination of both, for example. In FIGS. 4 and 5, for instance, it will be appreciated that lengthening stem 192 may allow node 191 to project or to extend as desired into conduit system 221; conversely, shortening stem 192 may raise node 191 entirely into well 111 (i.e. above the level of second opening 322 in FIGS. 4 and 5). More specifically, second opening 322 may allow node 191 to extend into conduit system 221, communicate liquid from conduit system 221 into well 111 facilitating contact with node 191, or both.

As described above, conduit system 221 may comprise one or more ducts, tubes, pipes, troughs, bores, or other structures suitably designed and coupled to communicate liquid specimen material between one or more manifolds and the respective second openings of wells in receiver 110. In some implementations, receiver 110 may generally comprise only the first section 121 of the structure illustrated in FIGS. 2E, 2F, and 5; in this arrangement, the second section 122 of the structure as well as conduit system 221 may generally be embodied in an array of troughs, a pool, tray, dish, pan, reservoir, or other similar container into which specimen material may be introduced as illustrated and described above with reference to FIGS. 2A-2F. First section 121, supporting a desired number of carriers 190, may be lowered, placed, “dunked,” or otherwise engaged with second section 122 until liquid specimen contacts nodes 191, enters wells 111 through second openings 322, or both.

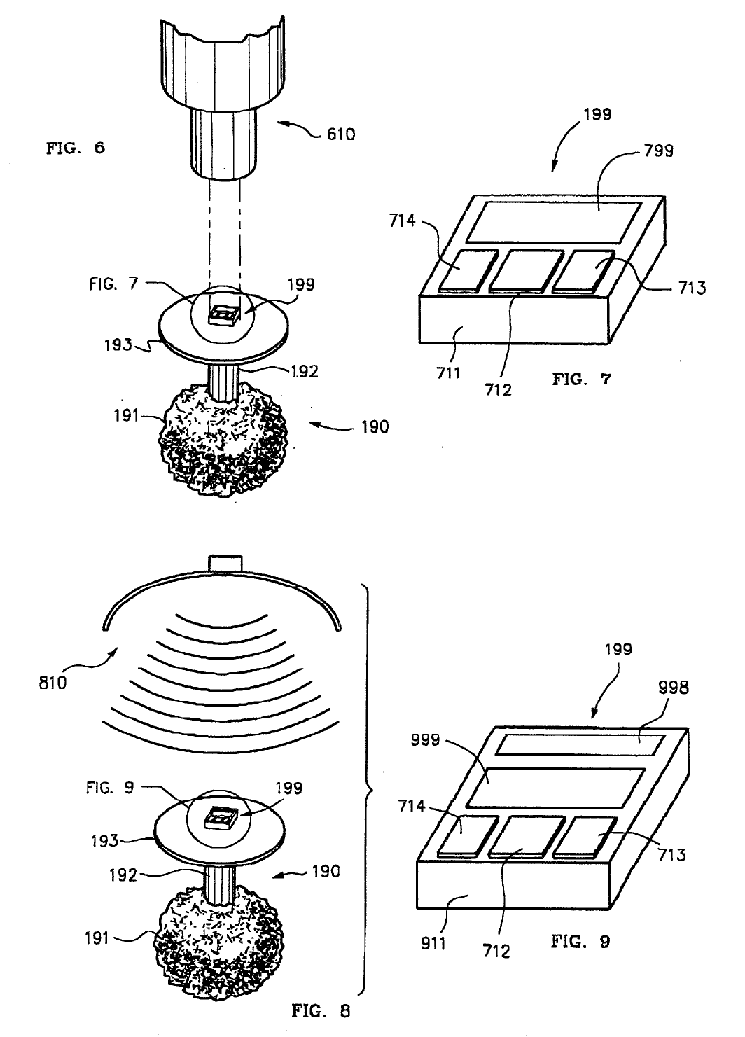

FIG. 6 is a simplified diagram illustrating another embodiment of a sample carrier, and FIG. 7 is a simplified diagram illustrating one embodiment of a sample identifier configured for use with the sample carrier embodiment of FIG. 6. Sample carrier 190 generally corresponds with those described above with reference to FIGS. 1-5, and may incorporate all of the structural elements and functional characteristics set forth in detail above.

In particular, identifier 199 (see FIG. 7) for use in conjunction with the sample carrier 190 of FIG. 6 may be embodied in a miniature light-activated transponder or transceiver 711. As is generally known in the art, visible, fluorescent, or coherent light or other suitable optical energy of a selected wavelength and frequency delivered by an appropriate source 610 such as a laser, for example, may provide energy to photovoltaic cell 799. In this embodiment, optical energy captured or received at cell 799 may power a microcontroller or microchip 712, additional circuitry and associated electronic memory 713, and a transmitter 714.

Microchip 712 may be embodied in any of various programmable logic controllers (PLCs), microcomputers, or other suitable circuitry known in the art. It will be appreciated that microchip 712 may access memory 713 both to store and to retrieve information associated with the co-located sample carried at node 191. When powered by energy emitted from source 610, microchip 712 may access data records and other information resident at memory 713 and activate transmitter 714 to transmit a signal representative of the information associated with the sample. Alternatively, transceiver 711 may be configured and operative to transmit a distinct or unique identifier code or signal associated with the co-located sample; data records and other information regarding the sample carried at node 191 may be accessed by another device in a remote location, for example, in accordance with the identification signal transmitted or broadcast by transmitter 714.

Identifier 199 comprising transceiver 711 may be incorporated into, or attached, adhered, or otherwise affixed to, identification structure 193. In some embodiments, transceiver 711 may be oriented such that photovoltaic cell 799 may receive optical energy from source 610 when carrier 190 is engaged with a receiver such as illustrated in FIGS. 3-5, for example, or a conventional multi-well plate used to store carrier 190. One or more additional identifiers 199 may be implemented in conjunction with carrier 190 depending, for example, upon the sophistication or functional characteristics of transceiver 711, the operational requirements of the system in which carrier 190 is employed, or a combination of both.

FIGS. 8 and 10 are simplified diagrams illustrating additional embodiments of a sample carrier, and FIG. 9 is a simplified diagram illustrating an embodiment of a sample identifier configured for use with the sample carrier embodiments of FIGS. 8 and 10.

Identifier 199 (see FIG. 9) for use in conjunction with the sample carrier 190 of FIGS. 8 and 10 may be embodied in a miniature radio frequency (RF) transponder or transceiver 911. RF energy of a selected wavelength and frequency delivered by an appropriate source 810 such as an antenna, for example, may be received by a suitable antenna 998 and provide energy to an RF cell 999 as is generally known in the art. In this embodiment, RF energy captured by antenna 998 and received at cell 999 may power a microcontroller or microchip 712, additional circuitry and associated electronic memory 713, and transmitter 714 substantially as described above with reference to FIGS. 6 and 7.

As described above, microchip 712 may access memory 713, retrieve information (resident at memory 713, for example) associated with the co-located sample carried at node 191, and activate transmitter 714 to transmit a signal representative of the information associated with the sample. Alternatively, transmitter 714 may transmit a distinct or unique identifier code or signal associated with the co-located sample.

While identifier 199 comprising transceiver 911 may be attached or affixed to identification structure 193 as set forth in detail above, implementation of transceiver 911 which is responsive to RF signals further facilitates the embodiment illustrated in FIG. 10. Since microchip 712 and other components of transceiver 911 are not dependent upon optical energy for operating power, for example, identifier 199 comprising transceiver 911 may be entirely integrated or contained within the structure of node 191. Accordingly, the FIG. 10 embodiment of sample carrier 190 may not include any structural components (such as stems or identification structures, for example) external or attached to node 191 as illustrated and described in detail above with reference to FIGS. 1-9.

FIG. 11 is a simplified diagram illustrating another embodiment of a sample carrier which may be operative in conjunction with the transceiver 911 of FIG. 9. In the exemplary FIG. 11 arrangement, node 191 generally comprises a first layer 1194 and a second layer 1195 of sample support medium. Identifier 199 generally comprising a transceiver such as illustrated and described above with reference to FIG. 9 may be interposed between layers 1194 and 1195. In some embodiments, layers 1194 and 1195 may generally be fabricated of filter paper or another suitable substrate such as the support medium disclosed in U.S. Pat. No. 6,294,203, incorporated by reference above.

As indicated by the rough textured appearance, layers 1194, 1195 in the exemplary FIG. 11 embodiment are depicted as filter paper or other porous material; it will be appreciated, however, that layers 1194, 1195 may alternatively be solid or non-porous. Any of the various sample support media set forth above may be suitable for layers 1194, 1195, and may be selected in accordance with fabrication techniques or other factors such as the operational characteristics of the automated handling mechanisms with which sample carrier 190 is intended to be used.

In some implementations, for example, it may be desirable to provide layers 1194, 1195 with sufficient rigidity to withstand manipulation by robotics or other handling mechanisms; such mechanical gripping apparatus, however, may potentially introduce contamination to the sample carried at node 191. Alternatively, identifier 199 housing or comprising a transceiver may be provided with sufficient thickness to accommodate such a gripping or handling device, such that layers 1194, 1195 are not contacted by any portion of the apparatus handling carrier 190.

FIG. 12 is a simplified diagram illustrating another embodiment of a sample carrier, and FIG. 13 is a simplified diagram illustrating one embodiment of a sample carrier receiver configured for use with the sample carrier of FIG. 12.

The sample carrier 190 of FIG. 12 generally comprises an identifier 199 embodied in an RF transponder 1211. As with the implementations described above with reference to FIGS. 8-11, applied electromagnetic energy may power transceiver 1211 which comprises an appropriate receiving antenna and a tuned capacitor (not shown). The capacitor drives electronics, including a transmitter, which may transmit a distinct or unique RF signal or code identifying the co-located sample carried at node 191.

In the foregoing embodiment, transceiver 1211 may be embedded within the sample support medium of node 191; alternatively, node 191 may be fabricated or constructed as a sheath or sleeve configured and operative to surround at least a portion of identifier 199. In some embodiments, for example, it may be desirable to limit the extent to which node 191 envelopes identifier 199; where node 191 is confined or limited to a portion of identifier 199 or housing of transceiver 1211, sample carrier 190 may be manipulated, mechanically or otherwise, without the risk that the handling device or grasping apparatus will make contact with, and potentially contaminate, the sample carried at node 191.

As indicated in FIG. 13, sample carrier 190 may be sized and dimensioned to engage a well 111 of sample carrier receiver 110 substantially as described above. It will be appreciated that carrier 190 may additionally comprise a gasket or other structure (not shown) operative to engage carrier 110 at first opening 321; such a gasket may support carrier 190 in a position allowing node 191 to contact liquid specimen communicated from conduit system 221 through second opening 322 as well as prevent contamination by precluding introduction of particulate matter to well 111 through first opening 321 when carrier 190 is engaged with receiver 110.

It should be noted that various types of transponders or transceivers such as those described above are currently known and employed in a wide variety of applications. For example, transponders similar to that represented by reference numeral 1211 are presently implanted in animals and are employed for identifying lost pets. Additionally, various micro-transceiver systems have been developed by researchers and proposed for use in active drug delivery techniques. As illustrated in FIGS. 10-12, for example, an electronic micro-transceiver may be integrated into a sample node 191; additionally or alternatively (as illustrated in FIGS. 6 and 8), such a transceiver may be attached to, or integrated into, identification structure 193 permanently co-located with sample node 191.

In that regard, a micro-transceiver or transponder such as described above may transmit omni-directional RF signals, for example, enabling a receiver at a robotic system to locate and to identify the sample carried at node 191 using associated signature signal frequencies, transmission patterns, or other information. In this embodiment, a unique signal transmitted by transceiver 711, 911, or 1211 may be used to direct the positioning of robotic instrumentation or sample handling apparatus.

With reference to the various embodiments of sample carrier 190 set forth in detail above, it will be appreciated that magnetic particles or ferromagnetic or ferrimagnetic materials may be implemented at sample node 191, at identification and handling structure 193, or both, to enable magnetic manipulation of sample carrier 190. In some embodiments, for example, magnetic material may be imbedded or otherwise incorporated into, or attached to, node 191, support medium, or identification structure 193. Accordingly, a magnetic field applied from a particular location relative to node 191 may orient sample carrier 190 into an appropriate position to facilitate reading or activating identifier 199. Further, sample carrier 190 may be handled, translated, or otherwise manipulated using magnetic chucks or other equipment capable of generating a suitable magnetic field.

Coated or uncoated magnetic particles or material may be incorporated into sample node 191 or sample support media during manufacture or following specimen loading, for example. In some such embodiments, node 191 may be produced or manufactured in a magnetic field such that incorporated magnetic material may be arranged in a desired magnetic orientation or polarization. Alternatively, such magnetic material may be added to the specimen material itself; magnetic material included in the specimen may be bound to sample node 191 with the same or similar chemistry employed to transfer the specimen to sample node 191.

It will be appreciated from the foregoing that the term “magnetic” in this context generally refers to magnetic, ferromagnetic, or ferrimagnetic properties causing a “magnetic” material to respond to external magnetic or electromagnetic fields. Accordingly, in some embodiments, sample carrier 190 may additionally comprise magnetic material such that sample carrier 190 may be oriented or otherwise manipulated responsive to an applied magnetic field.

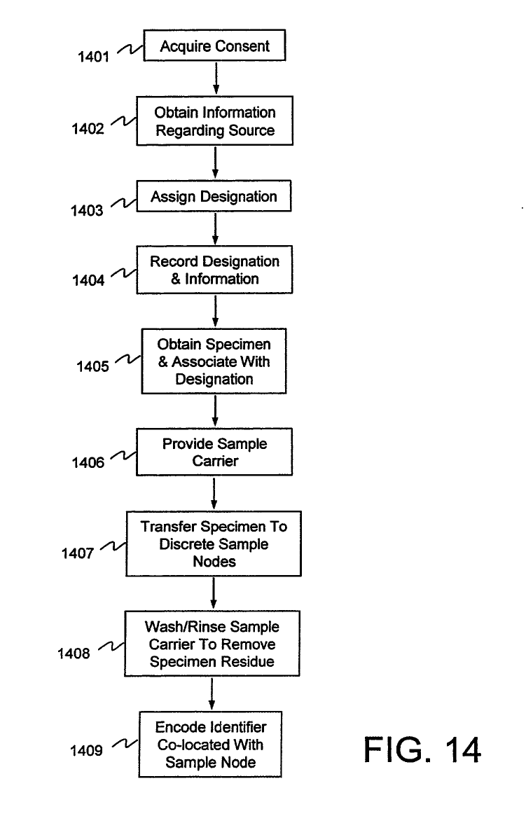

FIG. 14 is a simplified flow diagram illustrating one embodiment of a sample archival method. As indicated at block 1401, the storage or archival process may generally begin with acquiring consent from a patient or other specimen source. Much like the conventional archiving process, informed consent may be obtained by a professional recruiter after explaining the nature of the research to be conducted at an archive or laboratory facility and any techniques or technologies employed by the facility to ensure specimen source confidentiality. It will be appreciated that, in the case of non-biological specimens, for example, acquiring informed consent at block 1401 may be neither possible nor necessary.

Information concerning or relating to the specimen source may be obtained as indicated at block 1402. By way of example, a questionnaire or other form may be completed by the specimen source (e.g. a patient or a patient's guardian or representative) with the aid of a trained professional; the questionnaire or form may be electronic, prompting computer input responses. Additionally or alternatively, some or all of the information obtained from the specimen source may be oral or hand written; in this exemplary embodiment, a technician or data entry professional may input relevant information into a computer for recordation in a database. A standardized or modified computer spreadsheet or other proprietary application software which is compatible with the database may be used for data recordation. In some embodiments, data transcription errors may be minimized and maximum efficiency may be achieved where source- and specimen-specific information is input directly into a computerized system.

As noted above with reference to FIG. 1A, information associated with the sample which may be obtained as indicated at block 1402 may generally include some or all of the following: the nature or type of sample (e.g. blood, RNA, DNA, protein, environmental particles, or pollutants); the source or origin of the sample (e.g. age, gender, and medical history of a person, or the location and circumstances under which an environmental sample was collected); the time and date the sample was collected or archived; and the like.

As depicted at block 1403, a unique code, serial number, or other distinctive designation may be assigned to the information associated with the specimen and its source for cross-reference, tracking, and sample identification. As illustrated and described in detail above with reference to the various sample carrier embodiments, an identifier may comprise bar codes or other identifying indicia, transponders or transceivers, and the like which enable sample identification and tracking through distinct designations or codes. Accordingly, such identifiers may be encoded with the foregoing code, serial number, or designation such that the identifier may be used to cross-reference a specific sample with the appropriate associated information in accordance with the sample's unique designation. In the case of specimens and source-specific information, for example, such a designation may be assigned early in the archival process, possibly even before the specimen is obtained, as in the FIG. 14 embodiment. Identification of a specimen source and accurate association and cross-referencing with, for instance, the medical history of the source or other relevant information, may facilitate efficiency and proper interpretation of results in large-scale DNA or genomic studies, for example.

Data specific to the specimen and the source may be recorded as data records in a database as indicated at block 1404. As is generally known in the art, data records may be accessed or retrieved in accordance with the unique designation associated therewith and assigned as set forth above. Data storage media serving as central information repositories may be maintained at various locations in an archive or laboratory facility. Data may be transmitted to an archive facility, for example, via a network connection such as set forth in detail in the related applications incorporated herein by reference above. In that regard, a secure internet connection employing Secure Sockets Layer (SSL), a VPN connection, or other encryption technology may ensure data integrity and confidentiality of sensitive information. Information associated with each contributing specimen source and transmitted to the archive facility may be formatted in accordance with database requirements, for example, and subsequently made available to archive facility clients via the network connection; in some embodiments, database formats and access authorizations may be selected to preserve specimen source confidentiality.

Additionally or alternatively, an identifier permanently co-located with a sample node may maintain some or all of the data associated with the sample as noted above. In some embodiments, for example, a bar-code may be encoded with the foregoing types of information associated with the co-located sample, in addition to the designation or serial number; in other embodiments such as described above with reference to FIGS. 6-12, an identifier comprising electronic components may include sufficient circuitry or memory to maintain desired data records associated with the co-located sample.

A specimen may be obtained from the source and matched or associated with the correct unique designation as indicated at block 1405. For example, blood may be drawn from a patient by a member of a pathology nursing staff. A portion of a standard blood draw (e.g. approximately 1-5 ml of a total 10 ml draw) may be used to create samples for use in conjunction with a sample carrier as described in detail above.

In accordance with this embodiment, a sample carrier generally comprising a discrete sample node and a co-located identifier may be provided as indicated at block 1406. As set forth above, a sample node may be operative to carry a sample on a sample support medium. Some of the blood drawn may be deposited in a specimen container, for example, a test tube or one or more wells in a multi-well plate. In some embodiments, blood or other liquid specimen material may distributed to selected wells in a multi-well plate via a conduit system.

A sample carrier may selectively be placed in proximity to the specimen container such that a sample node is selectively exposed to specimen material. The sample support medium at the sample node may absorb, lyse, or otherwise bind the blood introduced to the specimen container. As set forth in detail above with reference to FIGS. 2B-5, a liquid specimen may be introduced to a well through a suitable opening in fluidic communication with a conduit system. In the foregoing exemplary manner, specimen material may be transferred to a discrete sample node as represented at block 1407. In some embodiments, preservatives may be applied or the sample node may be allowed to dry such that the sample is maintained in desiccated form.

A sample node or an entire sample carrier may be washed or rinsed, for example with detergents or other chemicals, to remove specimen residue or other contaminants from the sample node as is generally known in the art. The cleaning process, represented at block 1408, may reduce the risk of cross contamination potentially introduced by operation of sample handling apparatus or other equipment.

As described in detail above, a sample carrier may include an identifier operative to provide information associated with the co-located sample. In some embodiments, the identifier may comprise a bar-code, label, tag, or other unique identifying indicia decipherable by an optical scanner or machine vision technology. Additionally or alternatively, such an identifier may comprise one or more electronic devices such as a transponder or transceiver. In any event, an identifier permanently co-located with the sample node may facilitate automated or manual sample and sample carrier tracking.

An identifier co-located with a particular sample carrier may provide information related to the source of the specimen carried on the sample node. In accordance with the FIG. 14 embodiment, sample information and a unique designation may be recorded or encoded in the identifier as indicated at block 1409; this recordation may be coordinated with production or installation of the identifier for the sample carrier.

It will be appreciated that various alternatives exist with respect to the FIG. 14 embodiment, and that the presented order of the individual blocks is not intended to imply a specific sequence of operations to the exclusion of other possibilities; the particular application and overall system requirements may dictate the most efficient or desirable sequence of the operations set forth in FIG. 14. For example, specimen acquisition and association with a designation (represented at block 1405) may precede block 1404, or may even occur prior to obtaining source-specific information at block 1402, provided that appropriate provisions are made for assigning a unique designation. Similarly, encoding information in an identifier at block 1409 may precede, or occur simultaneously with, transfer of specimen material to the discrete sample node at block 1407 in certain situations.

The present invention has been illustrated and described in detail with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. A sample carrier comprising:
a sample node operative to carry a discrete sample; and
an identifier co-located with said sample node and operative to provide information associated with said discrete sample.

2. The sample carrier of claim 1 wherein said sample node is operative to carry a biological sample.

3. The sample carrier of claim 2 wherein said biological sample comprises a protein.

4. The sample carrier of claim 2 wherein said biological sample comprises a polynucleotide.

5. The sample carrier of claim 4 wherein said polynucleotide is RNA.

6. The sample carrier of claim 4 wherein said polynucleotide is DNA.

7. The sample carrier of claim 1 wherein said sample node is operative to carry a non-biological sample.

8. The sample carrier of claim 1 wherein said identifier comprises identifying indicia.

9. The sample carrier of claim 8 wherein said indicia are decipherable by an optical sensor.

10. The sample carrier of claim 9 wherein said indicia include a bar code.

11. The sample carrier of claim 1 wherein said identifier comprises a transceiver operative to transmit a signal identifying said discrete sample.

12. The sample carrier of claim 11 wherein said transceiver is further operative to receive a signal from a remote device.

13. The sample carrier of claim 12 wherein said transceiver receives operational power from energy in said signal.

14. The sample carrier of claim 12 wherein said signal comprises light.

15. The sample carrier of claim 14 wherein said signal comprises fluorescent light.

16. The sample carrier of claim 14 wherein said signal comprises coherent light.

17. The sample carrier of claim 12 wherein said signal comprises electromagnetic energy.

18. The sample carrier of claim 17 wherein said signal comprises radio frequency electromagnetic energy.

19. The sample carrier of claim 17 wherein said transceiver is internal to said sample node.

20. The sample carrier of claim 1 wherein said sample node is solid.

21. The sample carrier of claim 1 wherein said sample node is porous.

22. The sample carrier of claim 1 wherein said sample node comprises a sample support medium.

23. The sample carrier of claim 22 wherein said sample support medium comprises cellulose.

24. The sample carrier of claim 22 wherein said sample support medium comprises a polymer.

25. The sample carrier of claim 24 wherein said polymer is polystyrene.

26. The sample carrier of claim 24 wherein said polymer is chitosan.

27. The sample carrier of claim 22 wherein said sample support medium is derivatized.

28. The sample carrier of claim 27 wherein said sample support medium is positively charged.

29. The sample carrier of claim 27 wherein said sample support medium is negatively charged.

30. The sample carrier of claim 1 wherein said identifier is internal to said sample node.

31. The sample carrier of claim 1 wherein said identifier is permanently co-located with said sample node.

32. A sample carrier comprising:
a plurality of sample nodes supported in a predetermined spatial relationship; each of said plurality of sample nodes operative to carry a discrete sample; and
a plurality of identifiers; each respective one of said plurality of identifiers co-located with a respective one of said plurality of sample nodes and operative to provide information associated with said discrete sample.

33. The sample carrier of claim 32 wherein each of said plurality of sample nodes is supported in a predetermined spatial relationship relative to a respective specimen container.

34. The sample carrier of claim 32 wherein each of said plurality of sample nodes is supported in a predetermined spatial relationship relative to a respective well of a multi-well plate.

35. The sample carrier of claim 32 wherein each of said plurality of sample nodes is operative to carry a biological sample.

36. The sample carrier of claim 35 wherein said biological sample comprises a protein.

37. The sample carrier of claim 35 wherein said biological sample comprises a polynucleotide.

38. The sample carrier of claim 37 wherein said polynucleotide is RNA.

39. The sample carrier of claim 37 wherein said polynucleotide is DNA.

40. The sample carrier of claim 32 wherein each of said plurality of sample nodes is operative to carry a non-biological sample.

41. The sample carrier of claim 32 wherein each of said plurality of identifiers comprises identifying indicia.

42. The sample carrier of claim 41 wherein said indicia are decipherable by an optical sensor.

43. The sample carrier of claim 42 wherein said indicia include a bar code.

44. The sample carrier of claim 32 wherein each respective one of said plurality of identifiers comprises a respective transceiver operative to transmit a signal identifying said discrete sample.

45. The sample carrier of claim 44 wherein said respective transceiver is further operative to receive a signal from a remote device.

46. The sample carrier of claim 45 wherein said respective transceiver receives operational power from energy in said signal.

47. The sample carrier of claim 45 wherein said signal comprises light.

48. The sample carrier of claim 45 wherein said signal comprises fluorescent light.

49. The sample carrier of claim 45 wherein said signal comprises coherent light.

50. The sample carrier of claim 45 wherein said signal comprises electromagnetic energy.

51. The sample carrier of claim 45 wherein said signal comprises radio frequency electromagnetic energy.

52. The sample carrier of claim 51 wherein said respective transceiver is internal to said respective one of said plurality of sample nodes.

53. The sample carrier of claim 32 wherein each of said plurality of sample nodes is solid.

54. The sample carrier of claim 32 wherein each of said plurality of sample nodes is porous.

55. The sample carrier of claim 32 wherein each of said plurality of sample nodes comprises a sample support medium.

56. The sample carrier of claim 55 wherein said sample support medium comprises cellulose.

57. The sample carrier of claim 55 wherein said sample support medium comprises a polymer.

58. The sample carrier of claim 57 wherein said polymer is polystyrene.

59. The sample carrier of claim 57 wherein said polymer is chitosan.

60. The sample carrier of claim 57 wherein said sample support medium is derivatized.

61. The sample carrier of claim 60 wherein said sample support medium is positively charged.

62. The sample carrier of claim 60 wherein said sample support medium is negatively charged.

63. The sample carrier of claim 32 wherein each respective one of said plurality of identifiers is internal to said respective one of said plurality of sample nodes.

64. The sample carrier of claim 32 wherein each respective one of said plurality of identifiers is permanently co-located with said respective one of said plurality of sample nodes.

65. A method of transferring a specimen to a sample carrier; said method comprising:
providing a sample carrier comprising a sample node operative to carry a discrete sample and an identifier co-located with said sample node and operative to provide information associated with said discrete sample; and
contacting said sample node and said specimen.

66. The method of claim 65 wherein said specimen is a solid.

67. The method of claim 65 wherein said specimen is gaseous.

68. The method of claim 65 wherein said specimen is a liquid.

69. The method of claim 65 wherein said sample no de comprises a preservative.

70. The method of claim 65 further comprising washing said sample node subsequent to said contacting.

71. The method of claim 65 further comprising allowing said sample node to desiccate subsequent to said contacting.

72. The method of claim 65 wherein said identifier comprises a bar code identifying said specimen.

73. The method of claim 65 wherein said identifier comprises a transceiver operative to transmit a signal identifying said specimen.

74. The method of claim 65 wherein said identifier is permanently co-located with said sample node.

75. A method of transferring specimens to a sample carrier; said method comprising:
providing a sample carrier comprising a plurality of sample nodes supported in a predetermined spatial relationship relative to a respective specimen container and a plurality of identifiers, each respective one of said plurality of identifiers co-located with a respective one of said plurality of sample nodes and operative to provide information associated with said discrete sample; and
contacting selected ones of said plurality of sample nodes and a respective specimen.

76. The method of claim 75 wherein said contacting comprises bringing said plurality of sample nodes into contact with a specimen in said respective specimen container.

77. The method of claim 75 wherein said respective specimen is a solid.

78. The method of claim 75 wherein said respective specimen is gaseous.

79. The method of claim 75 wherein said respective specimen is a liquid.

80. The method of claim 75 wherein each of said plurality of sample nodes comprises a preservative.

81. The method of claim 75 further comprising washing selected ones of said plurality of sample nodes subsequent to said contacting.

82. The method of claim 75 further comprising allowing said plurality of sample nodes to desiccate subsequent to said contacting.

83. The method of claim 75 wherein each of said plurality of identifiers comprises a bar code identifying said respective specimen.

84. The method of claim 75 wherein each of said plurality of identifiers comprises a transceiver configured to transmit a signal identifying said respective specimen.

85. The method of claim 75 wherein each of said plurality of identifiers is permanently co-located with said respective one of said plurality of sample nodes.

86. A sample carrier comprising:
a sample node;
an identifier co-located with said sample node; and
a specimen carried by said sample node;
wherein said identifier is operative to provide information associated with said specimen.

87. The sample carrier of claim 86 wherein said specimen is biological.

88. The sample carrier of claim 87 wherein said specimen comprises a protein.

89. The sample carrier of claim 87 wherein said specimen comprises a polynucleotide.

90. The sample carrier of claim 89 wherein said polynucleotide is RNA.

91. The sample carrier of claim 89 wherein said polynucleotide is DNA.

92. The sample carrier of claim 86 wherein said specimen is non-biological.

93. The sample carrier of claim 86 wherein said sample node is solid.

94. The sample carrier of claim 86 wherein sample node is porous.

95. The sample carrier of claim 86 wherein said sample node comprises cellulose.

96. The sample carrier of claim 86 wherein said sample node comprises a polymer.

97. The sample carrier of claim 96 wherein said polymer is polystyrene.

98. The sample carrier of claim 96 wherein said polymer is chitosan.

99. The sample carrier of claim 86 wherein said sample node is derivatized.

100. The sample carrier of claim 86 wherein said sample node is treated with a chemical compound.

101. The sample carrier of claim 86 wherein said identifier comprises identifying indicia.

102. The sample carrier of claim 101 wherein said indicia include a bar code.

103. The sample carrier of claim 86 wherein said identifier comprises a transceiver operative to transmit a signal identifying said specimen.

104. The sample carrier of claim 103 wherein said transceiver is internal to said sample node.

105. The sample carrier of claim 86 wherein said identifier is permanently co-located with said sample node.

106. A sample carrier comprising:
a sample node operative to carry a discrete sample; and
an identifier permanently co-located with said sample node and operative to provide information associated with said discrete sample.

107. The sample carrier of claim 106 wherein said sample comprises a protein.

108. The sample carrier of claim 106 wherein said sample comprises a polynucleotide.

109. The sample carrier of claim 106 wherein said identifier comprises identifying indicia.

110. The sample carrier of claim 106 wherein said identifier comprises a transceiver operative to transmit a signal identifying said discrete sample.

111. The sample carrier of claim 110 wherein said transceiver is internal to said sample node.

112. The sample carrier of claim 106 wherein said sample node comprises a sample support medium.

113. The sample carrier of claim 112 wherein said sample support medium comprises cellulose.

114. The sample carrier of claim 112 wherein said sample support medium comprises a polymer.
